(19) United States
(12) Patent Application Publication
(10) Pub. No.: US 2003/0228817 A1
(43) Pub. Date: Dec. 11, 2003

(54) Material adapted to dissipate and reduce vibrations and method of making same

(75) Inventors: Robert A. Vito, Berwyn, PA (US); Thomas Falone, Michleton, NJ (US); Carmen A. DiMario, West Chester, PA (US)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: Innercore Grip Company, Berwyn, PA

(21) Appl. No.: 10/173,063

(22) Filed: Jun. 17, 2002

Related U.S. Application Data
(63) Continuation-in-part of application No. 10/165,748, filed on Jun. 7, 2002.

(51) Int. Cl. B32B 5/16; D03D 25/00; B32B 25/02; B32B 25/10; B32B 27/02

(52) U.S. Cl. 442/169; 442/164; 442/250; 442/260; 442/293; 442/294

(57) ABSTRACT

A material adapted to regulate vibration by distributing and partially dissipating vibration exerted thereon. The material includes an elastomer layer. A support structure is penetrated by and is embedded on and/or within the elastomer layer. The support structure is semi-rigid and supports the elastomer layer. Methods of making the material are also disclosed herein.

### CROSS REFERENCE TO RELATED APPLICATION

This application is a continuation in part of U.S. Patent Application entitled “Multi-Layer Material Adapted to Dissipate and Reduce Vibrations,” filed on Jun. 7, 2002, and invented by Robert A. Vito, Carmen DiMario, and Thomas Falone, serial number not yet known.

### BACKGROUND

The present invention is directed to a material adapted to reduce vibration and, more specifically, to a method of making a material adapted to dissipate and evenly distribute vibrations acting on the material.

Handles of sporting equipment, bicycles, hand tools, etc. are often made of wood, metal or polymer that transmit vibrations that can make the items uncomfortable for prolonged gripping. Sporting equipment, such as bats, balls, shoe insoles and sidewalls, also transmit vibrations during the impact that commonly occurs during athletic contests. These vibrations can be problematic in that they can potentially distract the player's attention, adversely effect performance, and/or injure a portion of a player's body.

Rigid polymer materials are typically used to provide grips for tools and sports equipment. The use of rigid polymers allows users to maintain control of the equipment but is not very effective at reducing vibrations. While it is known that softer materials provide better vibration regulation characteristics, such materials do not have the necessary rigidity for incorporation into sporting equipment, hand tools, shoes or the like. This lack of rigidity allows unintended movement of the equipment encased by the soft material relative to a user's hand or body.

Prolonged or repetitive contact with excessive vibrations can injure a person. The desire to avoid such injury can result in reduced athletic performance and decreased efficiency when working with tools.

Clearly what is needed is a method of making a material adapted to regulate vibration that provides the necessary rigidity for effective vibration distribution and for a user to maintain the necessary control of the implement; that can dampen and reduce vibrational energy; and that includes a support structure that is embedded on and/or within a main vibration dissipating material.

### SUMMARY

One embodiment of the present invention is directed to a material adapted to regulate vibration by distributing and partially dissipating vibration exerted thereon. The material includes an elastomer layer. A support structure is penetrated by and embedded on and/or within the elastomer layer. The support structure is semi-rigid and supports the elastomer layer.

In another aspect, the present invention is directed to a method of making a material adapted to regulate vibration. The method includes: providing an uncured elastomer; positioning a cloth layer formed by plurality of woven aramid fibers on and/or within the uncured elastomer, the uncured elastomer penetrates the cloth layer to embed the cloth layer; and at least partially curing the uncured elastomer to form the material, the cloth layer supporting the cured elastomer and facilitating the distribution and dissipation of vibration by the material.

In another aspect, the present invention is directed to a method of making a grip for an implement having a handle and a proximal end. The grip is formed by a single material adapted to regulate vibration. The method includes: providing an uncured elastomer; positioning a plurality of fibers within the uncured elastomer; at least partially curing the uncured elastomer to form the single layer material embedding the plurality of fibers therein, the single layer material having first and second major material surfaces; and positioning the single layer material over at least a portion of the handle and over the proximal end of the handle, the first major material surface contacting the implement and the second major material surface of the single layer material forming a surface for a user to grasp.

In another aspect, the present invention is directed to a method of making a material adapted to regulate vibration. The method includes: providing a cloth formed by a plurality of woven aramid fibers, the cloth having first and second major surfaces; placing a first elastomer layer on the first major surface of the cloth; and placing a second elastomer layer on the second major surface of the cloth, the first and second elastomer layers penetrating the cloth to form a single layer elastomer having an embedded cloth for support thereof.

In another aspect, the present invention is directed to a method of forming a material adapted to regulate vibrations. The method includes: providing a cloth layer; positioning an elastomer substantially over the cloth layer; and applying pressure to the cloth layer and the elastomer to embed the cloth layer to form the material.

In another aspect, the present invention is directed to material adapted to regulate vibration by distributing and partially dissipating vibration exerted thereon. The material includes a polymer layer. A support structure is penetrated by an embedded on and/or within the polymer layer. The support structure is semi-rigid and supports the polymer layer.

### BRIEF DESCRIPTION OF THE DRAWINGS

The foregoing summary, as well as the following detailed description of the preferred embodiments of the present invention will be better understood when read in conjunction with the appended drawings. For the purpose of illustrating the invention, there are shown in the drawings embodiments which are presently preferred. It is understood, however, that the invention is not limited to the precise arrangements and instrumentality shown. In the drawings:

FIG. 1 is a cross-sectional view of a preferred embodiment of the material of the present invention illustrating a single layer vibration dissipating material with a support structure embedded therein, the material extends along a longitudinal portion of an implement and covers a proximal end thereof;

FIG. 2 is a cross-sectional view of the material of FIG. 1 separate from any implement, padding, equipment or the like;

FIG. 2A is a cross-sectional view of a second preferred embodiment of the material of the present invention with the support structure embedded thereon and the vibration dissipating material penetrating the support structure;

FIG. 2B is cross-sectional view of a third preferred embodiment of the material of the present invention with the support structure embedded within the vibration dissipating material and the vibration dissipating material penetrating the support structure, the support structure is positioned off center within the vibration dissipating material;

FIG. 3 is a cross-sectional view of a first preferred embodiment of the support structure as taken along the lines 3-3 of FIG. 2, the support structure is formed of polymer and/or elastomer and/or fibers, either of which may contain fibers, passageways extend through the support structure allowing the vibration dissipating material to penetrate the support structure;

FIG. 4 is cross-sectional view of a second preferred embodiment of the support structure as viewed in a manner similar to that of FIG. 3 illustrating a support structure formed by woven fibers, passageways through the woven fibers allow the support structure to be penetrated by the vibration dissipating material;

FIG. 5 is cross-sectional view of a third preferred support structure as viewed in a manner similar to that of FIG. 3, the support structure formed by plurality of fibers, passageways past the fibers allow the vibration dissipating material to penetrate the support structure;

FIG. 6 is a side elevational view of the support structure of FIG. 3;

FIG. 7 is perspective view of the material of FIG. 1 configured to form a grip for a bat; and

FIG. 8 is perspective view of the material of FIG. 1 configured to form a grip for a racquet.

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made. The words “inwardly” and “outwardly” refer to directions toward and away from, respectively, the geometric center of the material and designated parts thereof. The term “implement,” as used in the specification and in the claims, means “any one of a baseball bat, racquet, hockey stick, softball bat, sporting equipment, firearm, or the like.” The above terminology includes the words above specifically mentioned, derivatives thereof, and words of similar import. Additionally, the words “a” and “one” are defined as including one or more of the referenced item unless specifically stated otherwise.

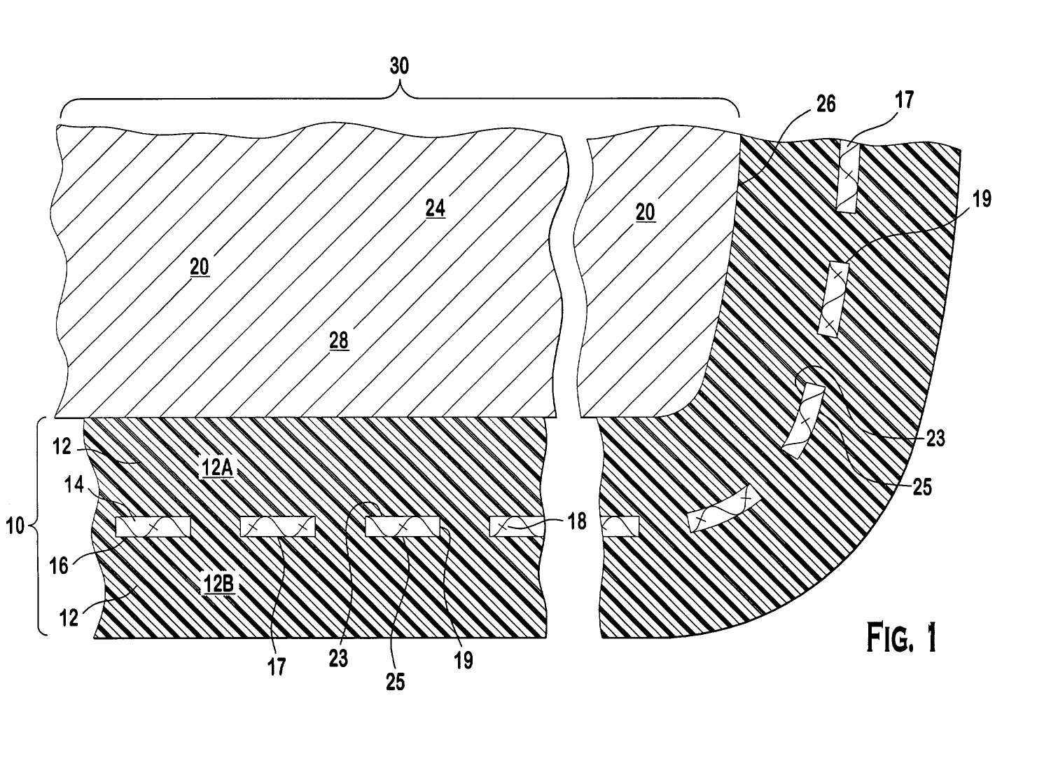

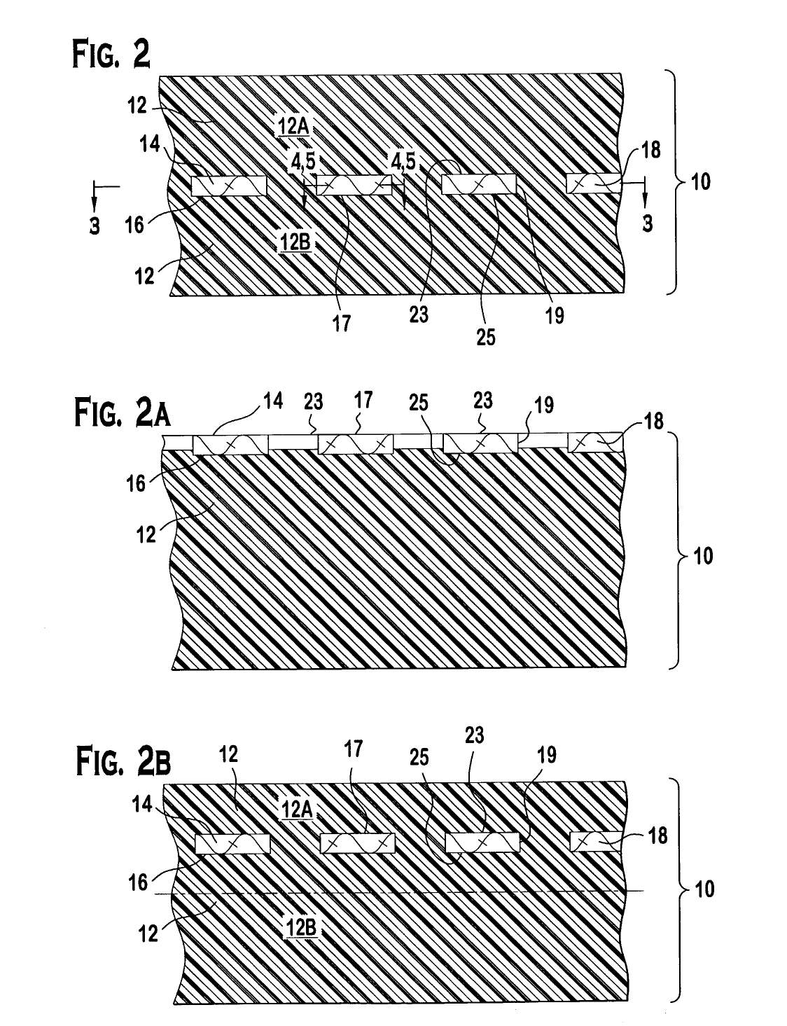

Referring to FIGS. 1-8, wherein like numerals indicate like elements throughout, there are shown preferred embodiments of a material, generally designated 10, that is adapted to regulate vibration. Briefly stated, the material 10 preferably includes a vibration dissipating material 12 (preferably an elastomer layer). The vibration dissipating material 12 penetrates a support structure 17 to embed the support structure 17 thereon (as shown in FIG. 2A) and/or therein (as shown in FIG. 2B). The support structure 17 is preferably semi-rigid and supports the vibration dissipating material 12.

The material 10 of the present invention was the result of extensive research and was throughly tested by Villanova University's Department of Mechanical Engineering by a professor having a Ph.D. in vibratory physics. Testing of the material 10 determined that the material 10 can reduce the magnitude of sensible vibration by eighty (80%) percent. The material 10 has verified, superior vibration dissipation properties due to the embedded support structure 17 that is located on and/or in the elastomer 12. In addition to evenly distributing vibration, the support structure 17 contributes to the absorption of vibration and supports the vibration dissipating material 12 to prevent the layer of vibration dissipating material 12 from twisting or otherwise becoming unsuitable for use as a grip or padding.

While it is preferred that the vibration dissipating material layer 12 be formed by elastomer, those of ordinary skill in the art will appreciate from this disclosure that the vibration dissipating material 12 can be formed by any suitable polymer without departing from the scope of the present invention. For clarity only, the vibration dissipating material 12 will be often described herein as being an elastomer without any mention of the material possibly being a polymer. However, it should understood that even when the layer 12 is only described as being an elastomer, that the present invention also includes the material 12 being a any suitable polymer.

The material 10 of the present invention can be incorporated into athletic gear, grips for sports equipment, grips for tools, and protective athletic gear. More specifically, the material 10 can be used: to form grips for a tennis racquet, hockey sticks, golf clubs, baseball bats or the like; to form protective athletic gear for mitts, headbands, mouth guards, face protection devices, helmets, gloves, pads, hip pads, shoulder pads, chest protectors, or the like; to form seats or handle bar covers for bicycles, motorcycles, or the like; to form boots for skiing, roller blading or the like; to form footwear, such as shoe soles and inserts; to form grips for firearms, hand guns, rifles, shotguns, or the like; and to form grips for tools such as hammers, drills, circular saws, chisels or the like.

The elastomer layer 12 acts as a shock absorber by converting mechanical vibrational energy into heat energy. The embedded support structure 17 redirects vibrational energy and provides increased stiffness to the material 10 to facilitate a user's ability to control an implement 20 encased, or partially encased, by the material 10. The incorporation of the support structure 17 on and/or within the material 10 allows the material 10 to be formed by a single elastomer layer without the material 10 being unsuitable for at least some of the above-mentioned uses. However, those of ordinary skill in the art will appreciate from this disclosure that additional layers of material can be added to any of the embodiments of the present invention disclosed below without departing from the scope of the invention.

It is preferred that the material 10 have a single contiguous elastomer body 12. Referring to FIG. 1, the support structure has first and second major surfaces 23,25. In one embodiment, the elastomer 12 extends through the support structure 17 so that the portion of the elastomer 12A contacting the first major support structure surface 23 (i.e., the top of the support structure 17) and the portion of the elastomer 12B contacting the second major support structure surface 25 (i.e., the bottom of the support structure) form the single contiguous elastomer body 12. Elastomer material provides vibration damping by dissipating vibrational energy. Suitable elastomer materials include, but are not limited, urethane rubbers, silicone rubbers, nitrile rubbers, butyl rubbers, acrylic rubbers, natural rubbers, styrene-butadiene rubbers, and the like. In general, any suitable elastomer or polymer material can be used to form the vibration dissipating layer 12.

The softness of elastomer materials can be quantified using Shore A durometer ratings. Generally speaking, the lower the durometer rating, the softer the material and the more effective a material layer is at absorbing and dissipating vibration because less force is channeled through the material. When a soft material is squeezed, an individual's fingers are imbedded in the material which increases the surface area of contact between the user's hand and creates irregularities in the outer material surface to allow a user to firmly grasp any implement 20 covered, or partially covered, by the material. However, the softer the material, the less control a user has when manipulating an implement 20 covered by the material. If the elastomer layer is too soft (i.e., if the elastomer layer has too low of a Shore A Durometer rating), then the implement 20 may rotate unintentionally relative to a user's hand or foot. The material 10 of the present invention is preferably designed a Shore A durometer rating that provides an optimum balance between allowing a user to precisely manipulate and control the implement 20 and effectively damping vibration during use of the implement 20 depending on the activity engaged in.

It is preferable, but not necessary, that the elastomer used with the material 10 have a Shore A durometer of between approximately ten (10) and approximately eighty (80). It is more preferred that the elastomer 12 have a Shore A durometer of between approximately fifteen (15) and approximately forty-five (45).

The elastomer 12 is preferably used to absorb vibrational energy and to convert vibrational energy into heat energy. The elastomer 12 also provides a compliant and comfortable grip for a user to grasp (or provides a surface for a portion of a user's body, such as the under sole of a user's foot when the material 10 is formed as a shoe insert).

In one embodiment, the material 10 preferably has a Shore A durometer of approximately fifteen (15). In another embodiment, the material 10 preferably has a Shore A Shore Durometer of approximately forty two (42). In yet another embodiment, the material 10 preferably has a Shore A Durometer of approximately thirty-two (32). Of course, those of ordinary skill in the art will appreciate that the Shore A Durometer of the material 10 can varied without departing from the scope of the present invention.

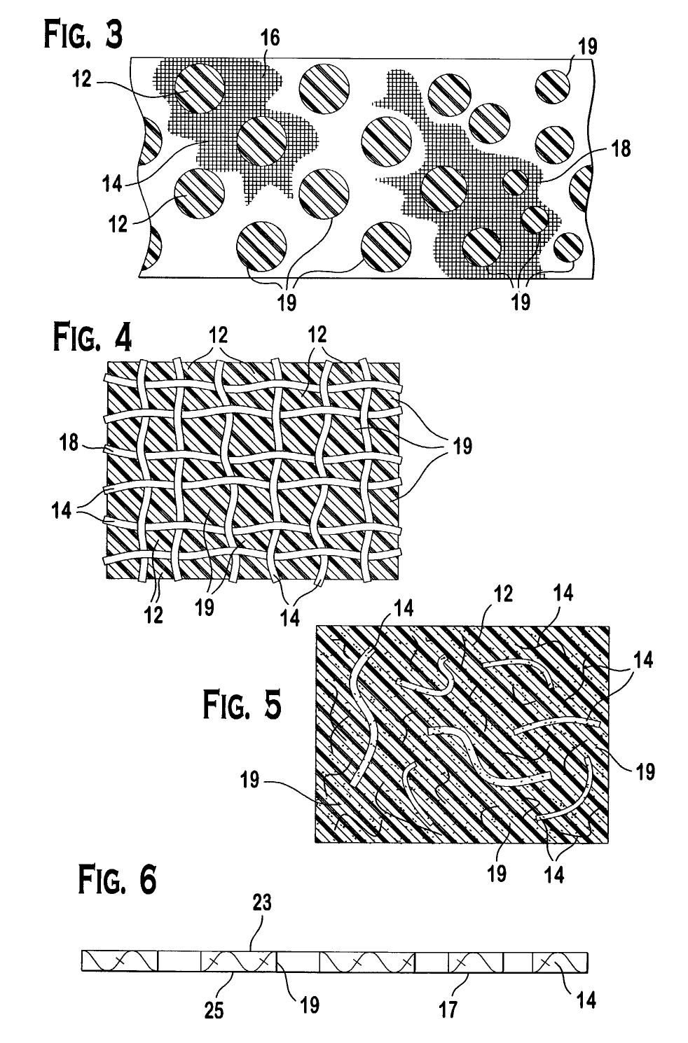

Referring to FIGS. 3-5, the support structure 17 can be any one (or combination of) of a polymer, an elastomer, a plurality of fibers, a plurality of woven fibers, and a cloth. If the support structure 17 and the layer 12 are both polymers or both elastomers, then they can be the same or different from each other without departing from the scope of the present invention. If vibration dissipating material is 12 if formed of the same material as the support structure 17, then the support structure 17 can be made more rigid than the main layer 12 by embedding fibers 14 therein. It is preferable that the support structure 17 is generally more rigid than the vibration dissipating material 12.

Referring specifically to FIG. 3, the support structure 17 may be formed of an elastomer that may but does not necessarily, also have fibers 14 embedded therein (examplary woven fibers are shown throughout portions of FIG. 3). Referring to FIG. 4, the support structure 17 may be formed by a plurality of woven fibers 18. Referring to FIG. 5, the support structure 17 may be formed by a plurality of fibers 14. Regardless of the material forming the support structure 17, it is preferable that passageways 19 extend into the support structure 17 to allow the elastomer 12 to penetrate and embed the support structure 17. The term “embed,” as used in the claim and in the corresponding portions of the specification, means “contact sufficiently to secure thereon and/or therein.” Accordingly, the support structure 17 shown in FIG. 2A is embedded by the elastomer 12 even though the elastomer 12 does not fully enclose the support structure 17. Additionally, as shown in FIG. 2B, the support structure 17 can be located at any level or height within the elastomer 12 without departing from the scope of the present invention. While the passageways 19 are shown as extending completely through the support structure 17, the invention includes passageways 19 that extend partially through the support structure 17.

Referring again to FIG. 2A, in one embodiment, it is preferred that the support structure 17 be embedded on the elastomer 12, with the elastomer penetrating the support structure 17. The support structure 17 being generally along a major material surface 38 (i.e., the support structure 17 is generally along the top of the material).

The fibers 14 are preferably, but not necessarily, formed of aramid fibers. Referring to FIG. 4, the fibers 14 can be woven to form a cloth 16 that is disposed on and/or within the elastomer 12. The cloth layer 16 can be formed of woven aramid fibers or other types of fiber. The aramid fibers 14 block and redirect vibrational energy that passes through the elastomer 12 to facilitate the dissipation of vibrations. The aramid fibers 18 redirect vibrational energy along the length of the fibers 18. Thus, when the plurality of aramid fibers 18 are woven to form the cloth 16, vibrational energy emanating from the implement 20 that is not absorbed or dissipated by the elastomer layer 12 is redistributed evenly along the material 10 by the cloth 16 and preferably also further dissipated by the cloth 16.

It is preferable that the aramid fibers 18 are formed of a suitable polyamide fiber of high tensile strength with a high resistance to elongation. However, those of ordinary skill in the art will appreciate from this disclosure that any aramid fiber suitable to channel vibration can be used to form the support structure 17 without departing from scope of the present invention. Additionally, those of ordinary skill in the art will appreciate from this disclosure that loose aramid fibers or chopped aramid fibers can be used to form the support structure 17 without departing from the scope of the present invention. The aramid fibers may also be formed of fiberglass or the like.

When the aramid fibers 18 are woven to form the cloth 16, it is preferable that the cloth 16 include at least some floating aramid fibers 18. That is, it is preferable that at least some of the plurality of aramid fibers 18 are able to move relative to the remaining aramid fibers 18 of the cloth 16. This movement of some of the aramid fibers 18 relative to the remaining fibers of the cloth converts vibrational energy to heat energy.

The material 10 may be configured and adapted to form an insert for shoe. When the material 10 is configured to form a shoe insert, the material 10 is preferably adapted to extend along an inner surface of the shoe from a location proximate to a heel of the shoe to the toe of the shoe. In addition to forming a shoe insert, the material 10 can be located along the sides of the shoe to protect the wearer's foot from lateral impact.

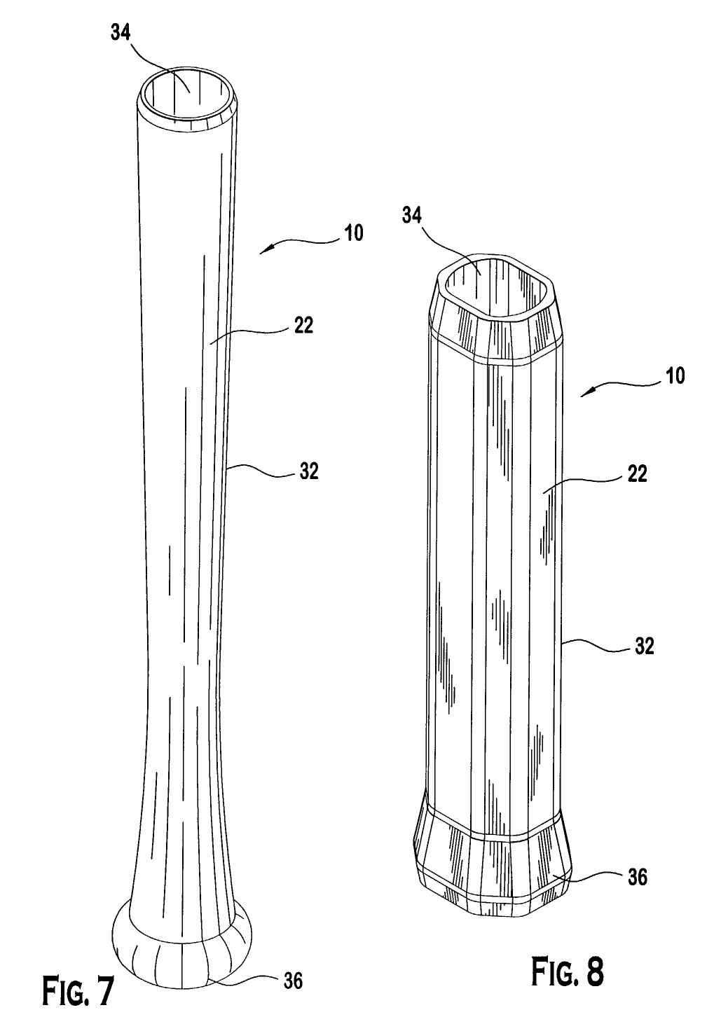

The material 10 may be configured and adapted to form a grip 22 for an implement such as a bat, having a handle 24 and a proximal end 26 (i.e., the end near to where the bat is normally gripped). The material 10 is preferably adapted to enclose a portion of the handle 24 and to enclose the proximal end 26 of the bat or implement 20. As best shown in FIGS. 7 and 8, it is preferable that the grip 22 be formed as a single body that completely encloses the proximal end of the implement 20. The material 10 may be also be configured and adapted to form a grip 22 for a tennis racket or similar implement 20 having a handle 24 and a proximal end 26.

While the grip 22 will be described below in connection with a baseball or softball bat, those of ordinary skill in the art will appreciate that the grip 22 can be used with any of the equipment, tools, or devices mentioned above without departing from the scope of the present invention.

When the grip 22 is used with a baseball or softball bat, the grip 22 preferably covers approximately seventeen (17) inches of the handle of the bat as well as covers the knob (i.e., the proximal end 26 of the implement 20) of the bat. The configuration of the grip 22 to extend over a significant portion of the bat length contributes to increased vibrational damping. It is preferred, but not necessary, that the grip 22 be formed as a single, contiguous, one-piece member.

Referring to FIG. 1, the baseball bat (or implement 20) has a handle 24 including a handle body 28 having a longitudinal portion 30 and a proximal end 26. The material 10 preferably encases at least some of the longitudinal portion 30 and the proximal end 26 of the handle 24. The grip material 10 can incorporate any of the above-described support structures 17. The aramid fiber layer 14 is preferably formed of woven aramid fibers 18.

As best shown in FIGS. 7 and 8, the preferred grip 22 is adapted for use with an implement 20 having a handle and a proximal handle end. The grip 22 includes a tubular shell 32 having a distal open end 34 adapted to surround a portion of the handle and a closed proximal end 36 adapted to enclose the proximal end of the handle. It is preferable not necessary, that the material completely enclose the proximal end 26 of the handle. The tubular shell 32 is preferably formed of the material 10 which dissipates vibration.

Multiple methods can be used to produce the composite or multi-layer material 10 of the present invention. Briefly speaking, one method is to extrude the material 10 by pulling a support structure 17 from a supply roll while placing the elastomer layer on both sides of the support structure 17. A second method of producing the material 10 of the present invention is to weave a fiber onto the implement 20 and then to mold the elastomer 12 thereover. Alternatively, a support structure can be pressure fit to an elastomer to form the material 10. Those of ordinary skill in the art will appreciate from this disclosure that any other known manufacturing methods can be used to form the material 10 without departing from the scope of the present invention. Any of the below described methods can be used to form a material 10 or grip 22 having any of the above specified Shore A Durometers and incorporating any of the above-described support structures 17.

More specifically, one preferred method of making the material 10 includes: providing an uncured elastomer 12. A cloth layer is positioned on and/or within the uncured elastomer 12. The cloth layer is formed by a plurality of woven aramid fibers 14. The uncured elastomer 12 penetrates the cloth layer 16 to embed to the cloth 16. The uncured elastomer 12 is at least partially cured to form the material 10. The cloth layer 16 supports the cured elastomer 12 and facilitates the distribution and dissipation of vibration by the material 10.

It is preferable that the elastomer 12 is cured so that some of the plurality of aramid fibers in the cloth layer 16 are able to move relative to the remaining plurality of aramid fibers 18. It is also preferable that the material 10 be configured to form a grip for a bat and/or racquet having a handle 24 and the proximal end 26. The grip 22 preferably encloses at least a portion of the handle 24 and the proximal end 26.

Another aspect of the present invention is directed to a method of making a grip 22 for an implement 20 having a handle 24 and a proximal end 26. The grip 22 is formed by a single layer material 10 adapted to regulate vibration. The method includes providing an uncured elastomer. A plurality of fibers 14 are positioned on and/or within the uncured elastomer 12. The uncured elastomer 12 is at least partially cured to form the single layer material embedding the plurality of fibers. The single layer material 10 has first and second major material surfaces. The single layer material 10 is positioned over at least a portion of the handle 24 and over the proximal end 26 of the handle 24. The first major material surface contacts the implement 20 and second major material surface of the single layer material 10 forms a surface for a user to grasp. This method can be used to form a grip 22 having any of the Shore A Durometers described above and can use any of the support structure 17 also described above.

In another aspect, the present invention is directed to a method of making a material 10 adapted to regulate vibration. The method includes providing a cloth 16 formed by a plurality of woven aramid fibers 14. The cloth has first and second major surfaces. A first elastomer layer 12A is placed on the first major surface of the cloth. A second elastomer layer 12B is placed on the second major surface 25 of the cloth 16. The first and second elastomer layers 12A, 12B penetrate the cloth 16 to form a single layer elastomer 12 having an embedded cloth 16 for support thereof

In another aspect, the present invention is directed to a method of forming a material 10 including providing a cloth layer 16. Positioning an elastomer 12 substantially over the cloth layer 16. Applying pressure to the cloth layer 16 and the elastomer 12 to embed the cloth layer 16 on and/or in the elastomer 12 to form the material 10. When using this sort of pressure fit technique, those ordinary skill in the art will appreciate from this disclosure that the cloth layer 16 and the elastomer 12 can be placed in a mold prior to applying pressure without departing from the scope of the present invention.

The covering of the proximal end of an implement 20 by the grip 22 results in reduced vibration transmission and in improved counter balancing of the distal end of the implement 20 by moving the center of mass of the implement 20 closer to the hand of a user (i.e., closer to the proximal end 26). This facilitates the swinging of the implement 20 and can improve sports performance while reducing the fatigue associated with repetitive motion.

It is recognized by those skilled in the art, that changes may be made to the above-described embodiments of the invention without departing from the broad inventive concept thereof For example, the material 10 may include additional layers (e.g., two or more additional layers) without departing from the scope of the present invention. It is understood, therefore, that this invention is not limited to the particular embodiments disclosed, but is intended to cover all modifications which are within the spirit and scope of the invention as defined by the appended claims and/or shown in the attached drawings.

We claim:

1. A material adapted to regulate vibration by distributing and partially dissipating vibration exerted thereon, the material comprising:
an elastomer layer; and
a support structure penetrated by and embedded on and/or within the elastomer layer, the support structure being semi-rigid and supporting the elastomer layer.

2. The material of claim 1, wherein the support structure has first and second major surfaces, the elastomer layer extending through the support structure so that the portion of the elastomer layer contacting the first major surface and the portion of the elastomer contacting the second major surface are part of a single contiguous elastomer body.

3. The material of claim 1, wherein the support structure comprises a polymer having a generally higher rigidity than the elastomer layer.

4. The material of claim 1, wherein the support structure comprises a second elastomer having a generally higher rigidity than the elastomer layer.

5. The material of claim 1, wherein the support structure comprises a plurality of fibers.

6. The material of claim 1, wherein the support structure is embedded in the single layer material with elastomer penetrating the support structure, the support structure being generally along a major material surface.

7. The material of claim 5, wherein the plurality of fibers are woven.

8. The material of claim 7, wherein the plurality of fibers comprise aramid fibers.

9. The material of claim 1, wherein the support structure comprises a second elastomer having a plurality of fibers embedded therein.

10. The material of claim 1, wherein the plurality of fibers are woven.

11. The material of claim 10, wherein the plurality of fibers comprise aramid fibers.

12. The material of claim 9, wherein the second elastomer is formed of the same elastomer as the elastomer layer, the plurality of fibers imparting rigidity to the second elastomer to make the support structure semi-rigid.

13. The material of claim 5, wherein the material is configured and adapted to form a grip for a tennis racquet having a handle and a proximal end, the material is adapted to enclose a portion of the handle and to enclose the proximal end of the tennis racquet.

14. The material of claim 5, wherein the material is configured and adapted to form a grip for an implement having a handle and a proximal end, the material is adapted to enclose a portion of the handle and to enclose the proximal end of the implement.

15. The material of claim 5, wherein the material is configured and adapted to form an insert for a shoe, the material being adapted to extend along an inner surface of the shoe from a location proximate to a heel of the shoe to a toe of the shoe.

16. The material of claim 9, wherein the material is configured and adapted to form a grip for a tennis racquet having a handle and a proximal end, the material is adapted to enclose a portion of the handle and to enclose the proximal end of the tennis racquet.

17. The material of claim 9, wherein the material is configured and adapted to form a grip for an implement having a handle and a proximal end, the material is adapted to enclose a portion of the handle and to enclose the proximal end of the implement.

18. The material of claim 9, wherein the material is configured and adapted to form an insert for a shoe, the material being adapted to extend along an inner surface of the shoe from a location proximate to a heel of the shoe to a toe of the shoe.

19. A method of making a material adapted to regulate vibration, comprising:
providing an uncured elastomer;
positioning a cloth layer formed by a plurality of woven aramid fibers on and/or within the uncured elastomer, the uncured elastomer penetrates the cloth layer to embed the cloth layer; and
at least partially curing the uncured elastomer to form the material, the cloth layer supporting the cured elastomer and facilitating the distribution and dissipation of vibration by the material.

20. The method of claim 19, wherein the elastomer is cured so that some of the plurality of aramid fibers in the cloth layer are able to move relative to the remaining plurality of aramid fibers.

21. The method of claim 19, further comprising configuring the material to form a grip for a bat having a handle and a proximal end, the grip enclosing at least a portion of the handle and enclosing the proximal end of the bat.

22. The method of claim 19, further comprising configuring the material to form a grip for a racquet having a handle and a proximal end, the grip enclosing at least a portion of the handle and enclosing the proximal end of the racquet.

23. A method of making a grip for an implement having a handle and a proximal end, the grip being formed by a single layer material adapted to regulate vibration, the method comprising:
providing an uncured elastomer;
positioning a plurality of fibers on and/or within the uncured elastomer;
at least partially curing the uncured elastomer to form the single layer material embedding the plurality of fibers, the single layer material having first and second major material surfaces; and
positioning the single layer material over at least a portion of the handle and over the proximal end of the handle, the first major material surface contacting the implement and the second major material surface of the single layer material forming a surface for a user to grasp.

29. A method of making a material adapted to regulate vibration, comprising:
providing a cloth formed by a plurality of woven aramid fibers, the cloth having first and second major surfaces;
placing a first elastomer layer on the first major surface of the cloth; and
placing a second elastomer layer on the second major surface of the cloth, the first and second elastomer layers penetrating the cloth to form a single layer elastomer having an embedded cloth for support thereof.

30. The method of claim 29, wherein the single layer elastomer has a Shore A Durometer of between approximately ten (10) and approximately twenty-five (25).

31. The method of claim 29, wherein the single layer elastomer has a Shore A Durometer of between approximately twenty-five (25) and approximately forty-five (45).

32. The method of claim 29, further comprising applying pressure to the single layer elastomer so that the elastomer further penetrates the cloth to form the material.

33. A method of forming a material adapted to regulate vibrations, the method comprising:
providing a cloth layer;
positioning an elastomer substantially over the cloth layer; and
applying pressure to the cloth layer and the elastomer layer to embed the cloth layer on and/or in the elastomer to form the material.

34. The method of claim 33, further comprising positioning the cloth layer and the elastomer in a mold prior to applying pressure.

35. A material adapted to regulate vibration by distributing and partially dissipating vibration exerted thereon, the material comprising:
an polymer layer; and
a support structure penetrated by and embedded on and/or within the polymer layer, the support structure being semi-rigid and supporting the polymer layer.

36. The material of claim 35, wherein the support structure comprises a plurality of fibers.

37. The material of claim 35, further comprising configuring the material to form a grip for an implement having a handle and a proximal end, the grip enclosing at least a portion of the handle and enclosing the proximal end of the implement.

38. The material of claim 37, wherein the grip is a single, contiguous member.

39. The material of claim 13, wherein the grip is a single, contiguous member.

40. The material of claim 14, wherein the grip is a single, contiguous member.
